(19) United States
(12) Patent Application Publication
(10) Pub. No.: US 2007/0218938 A1
(43) Pub. Date: Sep. 20, 2007

(54) Sleep Mode Systems and Methods

(75) Inventor: Trent R. Carter, Indiatlantic, FL (US)

Correspondence Address: THOMAS, KAYDEN, HORSTEMEYER & RISLEY, L.L.P., 100 GALLERIA PARKWAY, SUITE 1750, ATLANTA, GA, 30339-5948, US

(73) Assignee: Conexant Systems, Inc., Newport Beach, CA (US)

(21) Appl. No.: 11/688,274

(22) Filed: Mar. 20, 2007

Related U.S. Application Data
(60) Provisional application No. 60/784,971, filed on Mar. 20, 2006.

(51) Int. Cl. H04Q 7/20

(52) U.S. Cl. 455/528

(57) ABSTRACT

Embodiments of sleep mode systems and methods are disclosed. In one method embodiment, among others, a sleep mode method comprises commencing a sleep mode, and during the sleep mode, queuing a plurality of frames for a burst transmission.

### CROSS-REFERENCE TO RELATED APPLICATION

This application claims priority to copending U.S. provisional application having Ser. No. 60/784,971, filed on Mar. 20, 2006, which is entirely incorporated herein by reference.

### BACKGROUND

1. Field of the Invention

The present disclosure is generally related to communication systems, and, more particularly, is related to wireless communication systems and methods.

2. Related Art

Wireless communication systems are widely deployed to provide various types of communication, such as voice, data, and so on. Much has changed in the way of wireless devices from the early days of bulky walkie-talkies and base-mounted car phones. Miniaturization of components and advancements in protocols and methods over the years have resulted in cell phones that can rest on an ear lobe, multi-media entertainment devices like the IPOD that provide hours of entertainment while fitting comfortably in the palm of one's hand, or digital cameras that can store and transmit literally hundreds of pictures.

Consumers desire low-profile devices, but not at the expense of performance. For instance, consider power consumption. Regarding digital cameras, as one example, consumers often like to capture hundreds of images on a vacation, but not at the cost of replacing and/or recharging batteries every hour or two. One technique often employed by wireless devices to save power includes implementing a sleep mode. In a sleep mode, the media access controller (or arm core controller) and/or radio circuitry of a wireless network interface (e.g., wireless card) is turned off. During the sleep mode, a host processor coupled to the wireless network interface may access memory to retrieve a frame of data, and then the above-mentioned wireless network interface components “waken” or power-up to transmit the frame to another device, and then the sleep mode is commenced once again.

FIGS. 1A and 1B are schematic diagrams 10 and 20, respectively, that illustrate the transmission of transmission control protocol (TCP) frames of data in a wireless local area network (WLAN) at a 54 Mbps rate less a defined throughput to provide rates of 10 Mbps and 5 Mbps, respectively. For each figure, the top diagrams 102a, 102b represent TCP frames of approximately 400 microseconds duration (which includes a collision window, for instance of 64 microseconds duration), as one example, each separated by a defined interframe space (which includes intervals for TCP acknowledgement (ACK) frames) corresponding to the desired throughput. The bottom diagrams 104a, 104b of each respective diagram 10 and 20 represent the current consumption (e.g., in mA) for a given device corresponding to the transmission of frames. Generally, the lower the throughput, the lower the average current consumption. For instance, in one conventional implementation, average current draw is approximately 250 mA for the device associated with FIG. 1A and 234 mA for the device associated with FIG. 2A. As shown, transmission is on a per frame basis, resulting in a repeated pattern of transmit frame-sleep, transmit frame-sleep, etc., operation.

Although such sleep mode techniques are widely used, there are limitations in their use depending on the application and/or device. For instance, the time consumed to commence wake and sleep modes varies by device. In some devices, the combined event (wake and sleep mode commencement) may consume approximately ½ millisecond (msec), whereas in other devices, the combined event may consume up to 5 msecs. In some implementations, the time between transmissions or the transmission of frames may prevent the commencement of the sleep and wake modes, or at least negate any benefit in terms of power consumption. For instance, network interfaces (e.g., based on 802.11) of a wireless device, such as a network card of a digital camera, typically send frames at evenly spaced intervals as shown in FIGS. 1A and 1B, which can prevent the interface from entering into low power modes (e.g., sleep mode) in between frames. Further, such systems can draw a high amount of current (and hence consume a significant amount of power) during transmission.

### SUMMARY

Embodiments of sleep mode systems and methods are disclosed. In one system embodiment, among others, a sleep mode system comprises a memory and a processor configured with software to buffer a plurality of frames into the memory during a sleep mode, the plurality of frames destined for a single burst transmission.

In one method embodiment, among others, a sleep mode method comprises commencing a sleep mode, and during the sleep mode, queuing a plurality of frames for a burst transmission.

Other systems, methods, features, and advantages of the present disclosure will be or become apparent to one with skill in the art upon examination of the following drawings and detailed description. It is intended that all such additional systems, methods, features, and advantages be included within this description, and be within the scope of the present disclosure.

### BRIEF DESCRIPTION OF THE DRAWINGS

Many aspects of the disclosed systems and methods can be better understood with reference to the following drawings. The components in the drawings are not necessarily to scale, emphasis instead being placed upon clearly illustrating the principles of the disclosed systems and methods. Moreover, in the drawings, like reference numerals designate corresponding parts throughout the several views.

FIGS. 1A and 1B are schematic diagrams that illustrate data frame transmission on a per frame basis according to different throughputs in an exemplary wireless local area network.

FIG. 2 is a block diagram of an exemplary communication environment in which embodiments of sleep mode systems and methods can be implemented.

FIG. 3 is a block diagram that illustrates an embodiment of a sleep mode system executed in one or more of the devices shown in FIG. 2.

FIG. 4 is a flow diagram that illustrates an embodiment of a sleep mode method executed on one or more of the devices shown in FIG. 2.

FIG. 5 is a flow diagram that illustrates an embodiment of a sleep mode method executed on one or more of the devices shown in FIG. 2.

FIG. 6 is a schematic diagram that illustrates burst transmissions between an embodiment of a sleep mode system such as that shown in FIG. 3 and an access point as well as the corresponding current draw for components of the sleep mode system.

### DETAILED DESCRIPTION

Disclosed herein are various embodiments of sleep mode systems and methods, herein simply sleep mode systems. Such sleep mode systems implement a repeated process of queuing (e.g., buffering or caching) a plurality of frames during a sleep mode, commencing a wake mode to transmit the queued (or buffered) frames in a burst transmission, and then returning to the sleep mode to collect the frames for subsequent burst transmission during a wake mode. That is, devices (e.g., wired, or more typically, wireless) employing certain embodiments of the sleep mode systems and methods buffer several frames in memory, then send the buffered frames out as one contiguous packet burst with minimal interframe spacing. The buffering time is used to put the device employing the sleep mode systems and methods in a low power mode. In other words, implementing such sleep mode methods enables a wireless local area network (WLAN) device, and in particular, a WLAN device equipped with a slow host processor (e.g., cell phones with WiFi, PDAs, MICROSOFT ZOOM PLAYER, IPOD, etc., though not limited to slow processor embodiments or wireless devices) to possess good low power performance especially when sending data.

As explained above, conventional wireless devices typically commence a sleep mode (e.g., turning off the radio and/or media access controller or equivalent in a wireless network card), during which a host processor accesses a frame of data from memory. The frame of data is then provided to a wireless network card, in which the above-described componentry commences a wake mode and transmits the frame of data, and then subsequently returns to a sleep mode to recommence the above-described process. That is, frames of data are delivered on a per frame basis in a repeated transmit frame-short sleep, transmit frame-short sleep, etc., process.

In contrast, the sleep mode systems described herein provide for a repeated process of a sleep mode queue of a plurality of frames of data followed by a wake mode, during which the plurality of frames queued during the sleep mode are transmitted in a burst manner (high volume of data frames separated by minimal interframe space). Such sleep mode systems thus benefit from the reduced frequency of sleep and wake transitions, often resulting in a significant reduction in current consumption, hence improving performance by at least preserving battery life and reducing the thermal effects on components of a wireless device.

Although described in the context of wireless devices, at least some of the benefits that inure to wireless systems can be extended to wireline devices, and hence wireline devices are considered to be within the scope of the disclosure. Further, in one embodiment, a sleep mode refers to implementations where the radio (e.g., of the network card) is operating on a predefined clock (e.g., 32 KHz clock) and waiting to wake up for the next beacon to check for data waiting to be transmitted. In some embodiments, a power save mode refers to implementations where the client (e.g., wireless client or network client, such as a network card) is waking up every beacon to check for data waiting to be transmitted. Note further that the phrase “sleep mode” may also be referred to as an idle mode, hibernation mode, standby mode, or other designation that refers generally to a mode that is of lower power than an active mode (e.g., an active mode such as a wake mode).

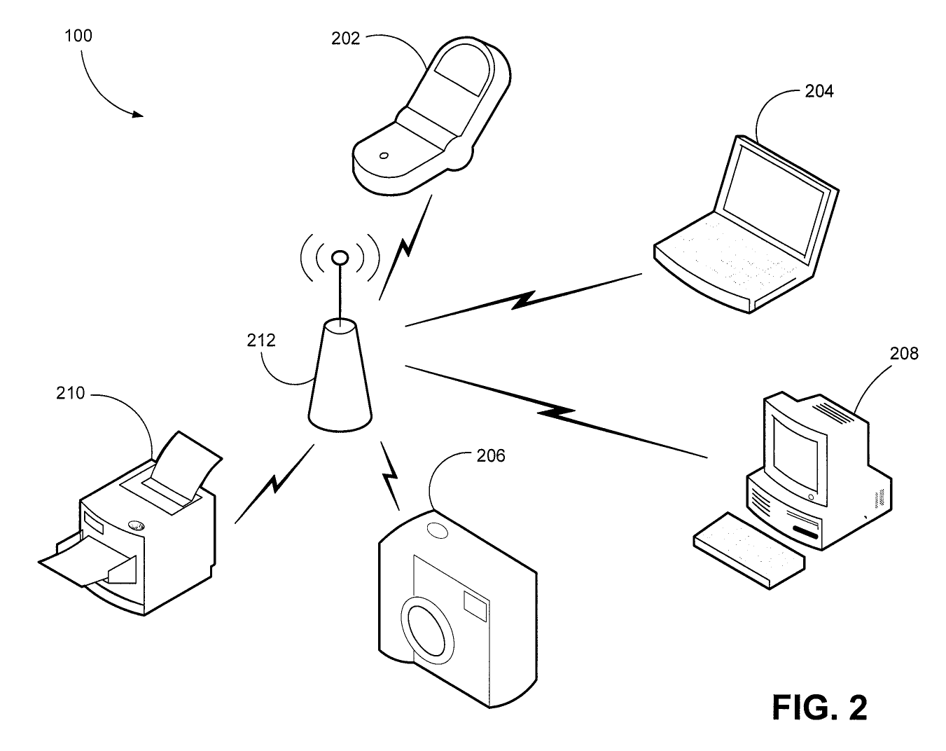

FIG. 2 is a block diagram of an exemplary communication environment 100 in which embodiments of sleep mode systems and methods can be implemented. The environment 100 comprises a plurality of wireless and wired devices, one or more of which may be configured to operate as a wireless and wired device. One or more of the devices shown in FIG. 2 may incorporate sleep mode systems and methods, as described further below. Exemplary wireless devices include a cell phone 202, a laptop computer 204, and a digital camera 206. The wired devices (e.g., with wireless capability) include a personal computer (PC) 208 and a printer 210. In the exemplary environment 100 shown in FIG. 2, the cell phone 202 is in communication (e.g., radio frequency communication) with the laptop 204 and the PC 208 via an access point (AP) 212, and the digital camera 206 is in communication with the printer 210 and the PC 208 via the AP 212. For instance, such communications may be used to load pictures from the digital camera 206 to the PC 208. Note that communication between the various devices may employ one or more of a plurality of protocols, including 802.11 (e.g., 802.11a, 802.11b, 802.11g, 802.11n), WiMax, Ultra-Wide Band (UWB), among other technologies (e.g., UMTA, TDMA 2000, etc.) that can employ a sleep mode in between the transmission of frames. Additionally, although the communication environment 100 is shown as a basic service set (BSS) configuration, in some embodiments, communication among one or more devices may be implemented using peer-to-peer (also known as adhoc in many wireless technologies) communication in lieu of or in addition to communication through the AP 212.

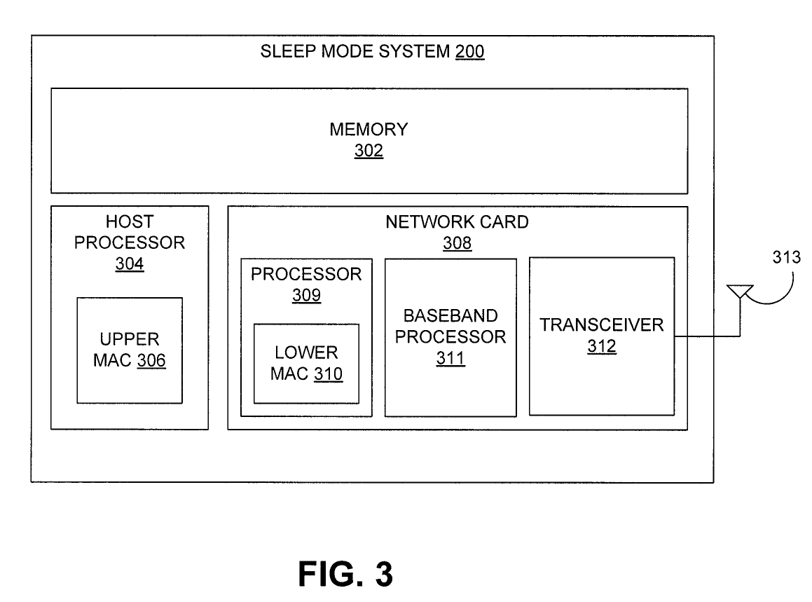

FIG. 3 is a block diagram that illustrates an embodiment of a sleep mode system 200 executed in one or more of the wireless devices shown in FIG. 2, such as the digital camera 206 as one example among others. Note that the devices shown in FIGS. 2 and 3 are exemplary in nature, and that the sleep mode system 200 may be implemented in one of a plurality of different devices or appliances, including computers (desktop, portable, laptop, etc.), consumer electronic devices (e.g., multi-media players, music players), compatible telecommunication devices, personal digital assistants (PDAs), or any other type of network devices, such as printers, fax machines, scanners, hubs, switches, routers, set-top boxes, televisions with communication capability, etc.

The sleep mode system 200 can be implemented using digital circuitry, analog circuitry, or a combination of both, and is embodied in one embodiment using a combination of hardware and software. As to hardware, one or more components of the sleep mode system 200 can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

In one embodiment, the sleep mode system 200 comprises a memory 302, a host processor (or media access controller in some embodiments) 304 executing code (e.g., a driver) referred to as also an upper MAC 306, and a network card 308 (e.g., network interface card or wireless card) coupled to the host processor 304, the network card 308 comprising a processor or media access controller 309 executing code referred to as a lower MAC 310, a baseband processor 311 coupled to the processor 309, a transceiver 312 coupled to the baseband processor 311, and an antenna 313 coupled to the transceiver 312. In some embodiments, the lower MAC 310 can be incorporated into the baseband processor 311. The transceiver 312 comprises in one embodiment such well-known transceiver components including filters, amplifiers (e.g., power amplifiers, switches, etc.). The host processor 304 and processor (media access controller) 309 may each be embodied as a digital signal processor (DSP), a microprocessor (MCU), a general purpose processor, or an application specific integrated circuit (ASIC), among others devices. One having ordinary skill in the art should appreciate that additional components not shown can be used (e.g., a host processor interface, various busses, etc.), yet which are omitted for brevity. In one embodiment, control of the queuing (buffering), sleep and wake activation, and transmission is performed in the upper MAC 306 in cooperation with the lower MAC 310. In some embodiments, such control is employed solely in either the upper MAC 306 or the lower MAC 310.

In one embodiment, the upper MAC 306 and lower MAC 310 each comprise software (e.g., firmware) residing on the respective processors 304 and 309, respectively, and that is executed by a suitable instruction execution system. In some embodiments, functionality of the upper MAC 306 and lower MAC 310 may comprise software stored in memory (e.g., memory 302) or other computer readable medium (e.g., optical, magnetic, semiconductor, etc.), and executed by the host processor 304 or other processor.

With respect to the combined operation of the upper MAC 306 and the lower MAC 310, the lower MAC 310 commences a sleep mode, and the upper MAC 306 buffers (or equivalently, caches or queues) a plurality of data frames to memory 302 during the sleep mode. During the sleep mode in one embodiment, the lower MAC 310, processor 309, baseband processor 311, and transceiver 312 are in a low power state (e.g., lower power than in the active or wake state). In one embodiment, upon reaching a predefined storage capacity in memory 302, the lower MAC 310 commences a wake mode, receives (e.g., via direct memory access, retrieval, etc.) the plurality of data frames from memory 302, and transmits the plurality of data frames in a burst transmission. In some embodiments, data frames may be buffered by the lower MAC 310 using memory 302 or different memory (not shown). For instance, in certain embodiments where data frames are buffered by the lower MAC 310, the sleep mode involves the baseband processor 311 and the transceiver 312 in a low power state (e.g., lower power than in the active or wake state).

In some embodiments, the sleep mode system 200 may be configured (e.g., preprogrammed or operator configurable through a user interface such as a touch-screen display and/or buttons located on and/or associated with a device) to throttle the maximum throughput to reduce power (e.g., via adjustment of the maximum transfer speed of say, digital images, or adjust the interframe space duration or number of frames).

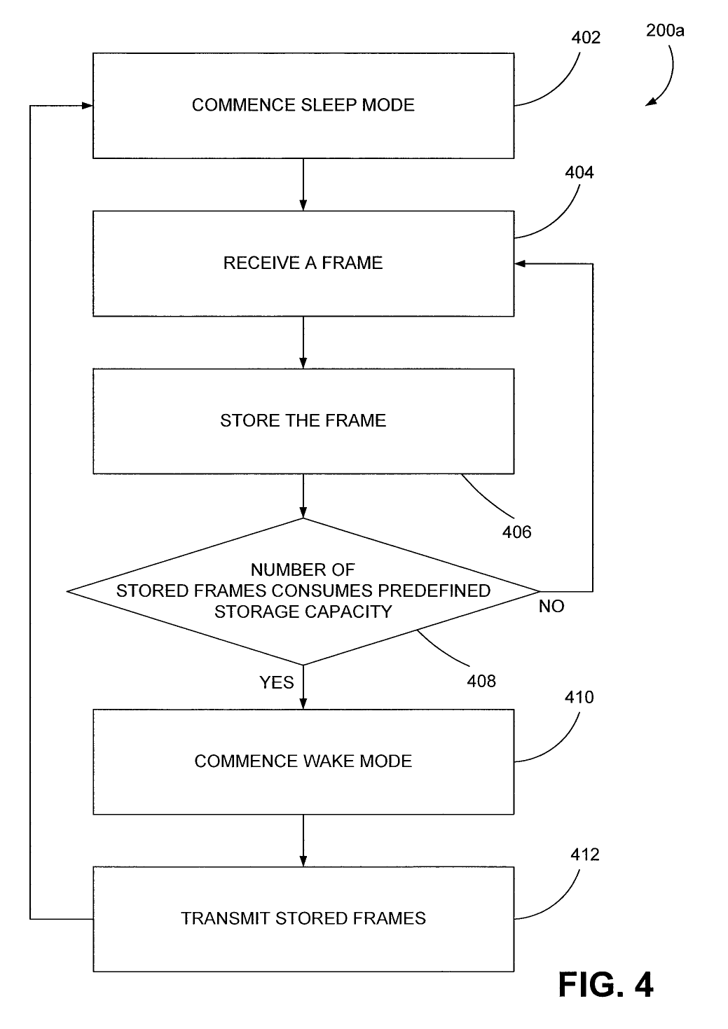

Having described one embodiment of a sleep mode system 200, one corresponding sleep mode method embodiment, denoted as method 200a and shown in FIG. 4, comprises the upper MAC 306 commencing a sleep mode for the network card 308 (402), receiving a frame from the host processor 304 (404), storing the frame in memory 302 (406), and determining whether the number of stored frames consumes a predefined storage capacity of the memory (408). If the stored frames do not consume a predefined storage capacity, then a next data frame is received (404) and the process resumes as explained above. If the stored frames do consume a predefined storage capacity, then the lower MAC 310 commences a wake mode (410), and effects transmission of the plurality of data frames in a single burst transmission (412). For instance, in some embodiments, the host processor 304 (or an associated host processor adapter or interface, not shown) provides an interrupt signal that wakes the lower MAC 310.

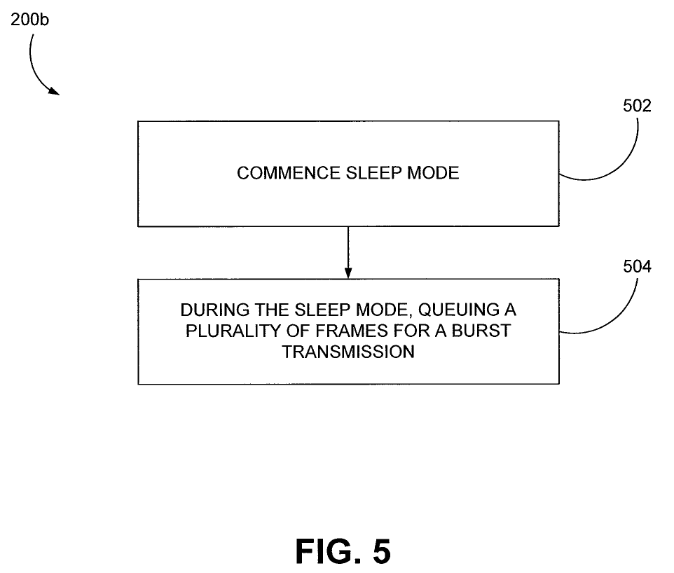

Having described one sleep mode method embodiment 200a employed by the sleep mode system 200 shown in FIG. 3, it should be appreciated that a more general sleep mode method, denoted as sleep mode method 200b and shown in FIG. 5, comprises commencing a sleep mode (502), and during the sleep mode, queuing a plurality of frames for a burst transmission (504).

Any process descriptions or blocks in flow diagrams should be understood as representing modules, segments, or portions of code which include one or more executable instructions for implementing specific logical functions or steps in the process, and alternate implementations are included within the scope of the embodiments described herein in which functions may be executed out of order from that shown or discussed, including substantially concurrently or in reverse order, depending on the functionality involved, as would be understood by those reasonably skilled in the art. Additionally, the methods 200a, 200b illustrated in the flow diagrams of FIGS. 4 and 5 are not limited to the system embodiments shown in FIGS. 2 and 3, but may be extended to other architectures and systems as should be appreciated by one having ordinary skill in the art in the context of this disclosure.

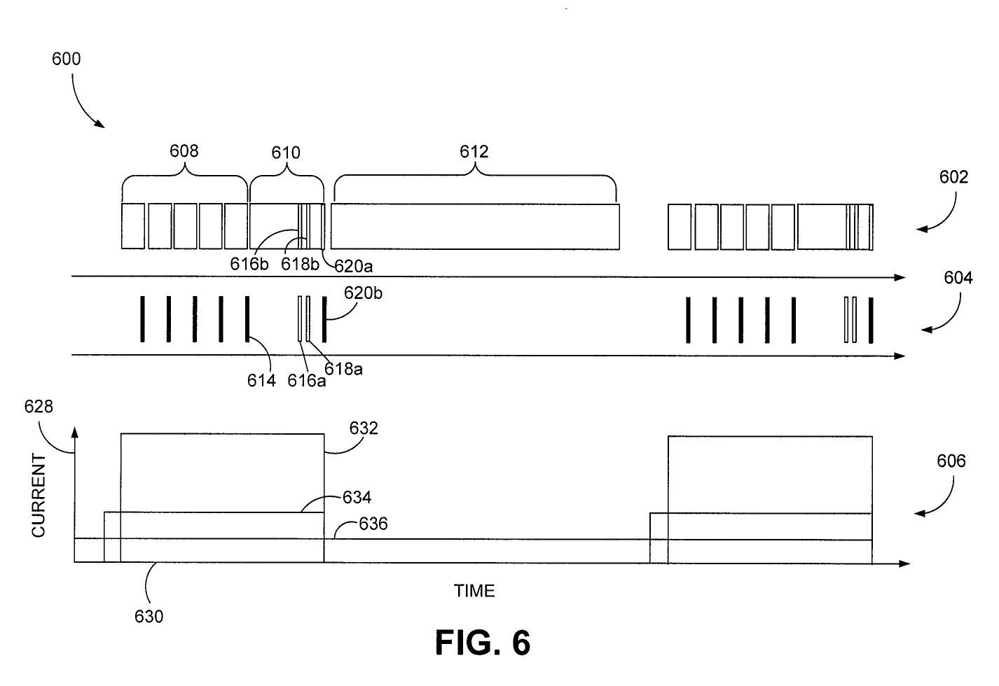

FIG. 6 is a schematic diagram 600 that illustrates exemplary, non-limiting burst transmissions between the sleep mode system 200 and the AP 212 and corresponding current draw for components of the sleep mode system 200. In particular, the schematic diagram 600 illustrates the transmission of transmission control protocol (TCP) frames of data in a wireless local area network (WLAN) at a 54 Mbps rate less a defined throughput to provide a rate of 10 Mbps, according to the mechanisms employed by the sleep mode systems and methods described herein. Note that the use of a TCP protocol is demonstrated for exemplary, non-limiting purposes, and that some embodiments may use a user datagram protocol (UDP), Internet control message protocol (ICMP), among other network layer protocols. Further, the use of a rate of 10 Mbps is for illustrative purposes, and one having ordinary skill in the art should appreciate in the context of this disclosure that other rates and throughputs may be implemented and are considered within the scope of this disclosure. As explained above, embodiments of the sleep mode system 200 can significantly reduce the power consumed by a device embodying such a system when transmitting over a WLAN interface (e.g., network card 308). Such power savings may be achieved by creating long periods of WLAN idle time, such that the network card 308 can exist for an extended duration in low power states. The large periods of time are created by buffering multiple data frames in memory 302 and sending them all at once, instead of sending them at regular intervals, hence reducing power.

Referring generally to FIG. 6, the top diagram 602 illustrates TCP frames transmitted by the sleep mode system 200, each of approximately 330 microseconds duration. One having ordinary skill in the art should appreciate in the context of this disclosure that duration values other than those shown in FIG. 6 (e.g., 330 microseconds) may be implemented, depending for instance on the modulation rate (e.g., 54 Mbps, 48 Mbps, etc.). Accordingly, transmit times can vary based on the implemented modulation rate. The middle diagram 604 in FIG. 6 illustrates the acknowledgment frames sent by the AP 212 according to TCP and 802.11 mechanisms. The bottom diagram 606 illustrates the current draw for various components of the sleep mode system 200.

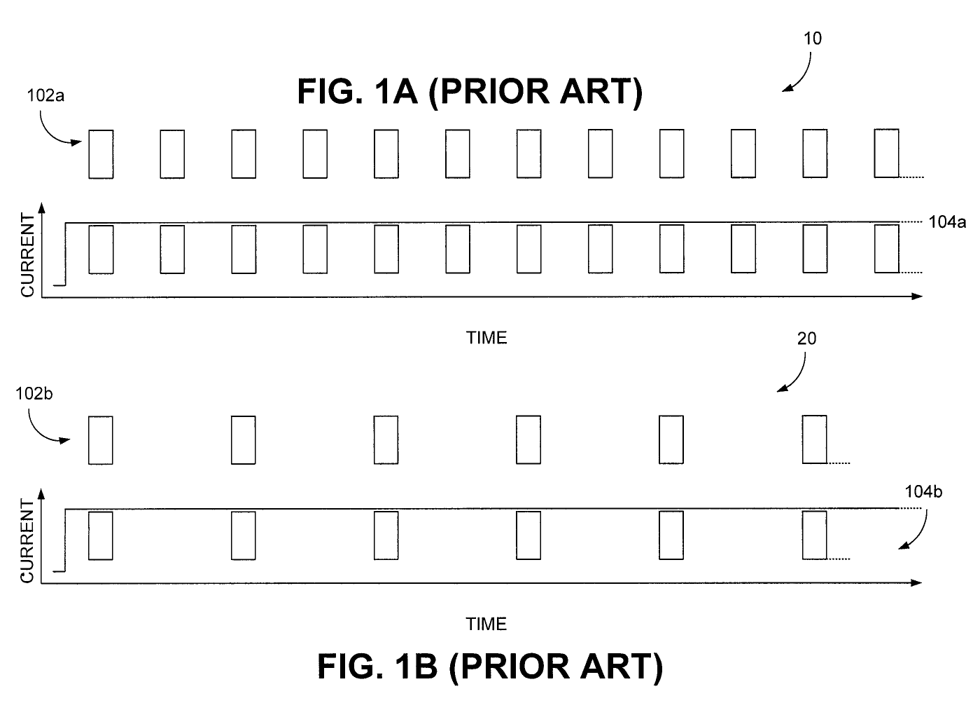

Referring to the top diagram 602, a contiguous burst transmission period denoted by reference numeral 608 comprises a plurality of transmitted TCP frames, each of 330 microsecond duration. The reduction from 400 to 330 microseconds (when compared to FIG. 1A for a similar modulation rate) in this example is the result of the omission of a 64 microsecond collision window due to the packet bursting of frames. Each TCP frame transmission by the sleep mode system 200 prompts a corresponding 802.11 acknowledgement (ACK) frame 614 by the AP 212, as illustrated in the middle diagram 604. A waiting period 610 follows the last TCP frame of the burst transmission corresponding to burst transmission period 608. During the waiting period 610, the sleep mode system 200 expects TCP ACK frames 616a and 618a from the AP 212 (the receipt of which are denoted by TCP ACK frames 616b and 618b, respectively). After reception of the TCP ACK frames 616b and 618b, the sleep mode system 200 sends a null data frame 620a (e.g., comprising a power save (PS) bit equal to 1) to the AP 212 indicating that the sleep mode system 200 has commenced the sleep mode. The receipt of the null data frame 620b is shown in the middle diagram 604. In one exemplary implementation, based on the exemplary values and rates provided above, the waiting period 610 comprises a duration of approximately 1 millisecond (msec).

Following the waiting period 610 is a sleep mode period denoted by reference numeral 612.

Referring now to the bottom diagram 606, shown is the sleep mode component current consumption (y-axis 628, using for example current units of milliamperes (mA)) for the corresponding burst transmission and sleep mode periods (x-axis 620, using for example time units of microseconds) shown in the top diagram 602. Three current levels are shown, including the transceiver current consumption 632, the lower MAC current consumption 634, and the upper MAC current consumption 636. As shown, the current consumption 632 and 634 illustrates periods of high and low levels, depending on whether a burst transmission is occurring or not, respectively. The upper MAC current consumption 636 maintains a relatively constant low level current draw throughout operation of the sleep mode system 200. Thus, the current consumption corresponding to the transceiver and lower MAC display periods of relative high and low regions corresponding to burst transmissions and sleep modes, respectively, hence providing an appearance similar to a periodic pulse waveform. In one embodiment, the average current consumption is approximately 99 mA, which when compared to the device associated with FIG. 1A using similar specifications, represents an approximately 60% reduction in system power (e.g., savings=(actual TCP throughput/max TCP throughput)×transmit power during max TCP throughput).

It should be emphasized that the above-described embodiments are merely possible examples of implementations, merely set forth for a clear understanding of the principles of the disclosure. Many variations and modifications may be made to the above-described embodiment(s) without departing substantially from the scope of the disclosure. All such modifications and variations are intended to be included herein within the scope of this disclosure.

At least the following is claimed:

1. A method, comprising:
commencing a sleep mode; and
during the sleep mode, queuing a plurality of frames for a burst transmission.

2. The method of claim 1, further comprising commencing a wake mode at a time corresponding to reaching a predefined storage capacity.

3. The method of claim 2, wherein commencing the wake mode comprises terminating the sleep mode.

4. The method of claim 1, further comprising transmitting the plurality of frames in the burst transmission responsive to commencing the wake mode.

5. The method of claim 4, wherein transmitting comprises contiguously transmitting the plurality of frames.

6. The method of claim 4, further comprising enabling selection of a configurable number of the plurality of frames transmitted in the burst transmission, enabling selection of a configurable interframe space duration between the plurality of frames delivered in the burst transmission, or a combination of both.

7. The method of claim 1, wherein queuing comprises storing a plurality of frame packets in memory.

8. The method of claim 1, wherein the commencing and queuing are implemented in an appliance.

9. A system, comprising:
a memory; and
a processor configured with software to buffer a plurality of frames into the memory during a sleep mode, the plurality of frames destined for a single burst transmission.

10. The system of claim 9, wherein the processor is further configured with the software to commence a wake mode at a time corresponding to the memory reaching a predefined memory capacity.

11. The system of claim 9, wherein the processor is further configured with the software to commence the wake mode at a time corresponding to terminating the sleep mode.

12. The system of claim 9, wherein the processor is further configured with the software to transmit the plurality of frames in the burst transmission responsive to commencing the wake mode.

13. The system of claim 12, wherein the processor is further configured with the software to contiguously transmit the plurality of frames.

14. The system of claim 12, further comprising a device configured to receive the plurality of frames in the burst transmission.

15. The system of claim 9, further comprising a user interface configured to enable selection of a configurable number of the plurality of frames transmitted in the burst transmission, configured to enable selection of a configurable interframe space duration between the plurality of frames delivered in the burst transmission, or a combination of both.

16. The system of claim 9, further comprising a second processor communicatively coupled to the memory, the second processor configured with second software to transmit the plurality of frames in the burst transmission responsive to commencing a wake mode.

17. The system of claim 16, wherein the second processor is further configured with the second software to determine whether the memory has reached a predefined memory capacity.

18. The system of claim 16, further comprising a device configured to receive the plurality of frames in the burst transmission.

19. The system of claim 16, wherein the second processor is further configured with the second software to determine whether the memory has reached a predefined memory capacity.

20. The system of claim 9, wherein the memory and the processor configured with the software reside in an appliance.

21. A system, comprising:
means for commencing a sleep mode; and
means for buffering, during the sleep mode, a plurality of frames for a burst transmission.

22. The system of claim 21, further comprising means for transmitting the plurality of buffered frames in the burst transmission responsive to commencing a wake mode.

23. The system of claim 21, wherein the means for commencing and the means for buffering reside in an appliance.
